(19) United States
(12) Patent Application Publication
(10) Pub. No.: US 2013/0313766 A1
(43) Pub. Date: Nov. 28, 2013

(54) METHOD FOR MANUFACTURING A SUSPENSION BEARING DEVICE, DEVICE AND STRUT COMPRISING SUCH A DEVICE

(71) Applicants: Sylvain Bussit, Monnaie (FR); Richard Corbett, FONDETTES (FR); Christophe Houdayer, SEMBLANCAY (FR); Bruno Montboeuf, CERELLES (FR); Adrien Nerriere, Amiens (FR); Samuel Viault, SAINT ANTOINE DU ROCHER (FR); Desire Vidot, Ballan-Mire (FR)

(72) Inventors: Sylvain Bussit, Monnaie (FR); Richard Corbett, FONDETTES (FR); Christophe Houdayer, SEMBLANCAY (FR); Bruno Montboeuf, CERELLES (FR); Adrien Nerriere, Amiens (FR); Samuel Viault, SAINT ANTOINE DU ROCHER (FR); Desire Vidot, Ballan-Mire (FR)

(73) Assignee: AKTIEBOLAGET SKF, Goteborg (SE)

(21) Appl. No.: 13/874,918

(22) Filed: May 1, 2013

(30) Foreign Application Priority Data
May 4, 2012 (FR) 1254137

(51) Int. Cl. F16C 33/76; B60G 15/00; F16C 19/14

(52) U.S. Cl. CPC F16C 33/761; F16C 19/14; B60G 15/00
USPC 267/195; 156/60; 264/259; 384/607

(57) ABSTRACT

The present invention relates to a method for manufacturing a suspension bearing device, comprising at least one rolling bearing, a bottom cup and a top cup made of plastic, each in contact with the rolling bearing, and at least one seal suitable for protecting the rolling bearing from ingress of water or of polluting particles. The method is characterized in that it comprises at least one step of positioning a seal made of thermosetting elastomer on a supporting element made of plastic between the bottom cup and the top cup and, for the or each seal made of thermosetting elastomer, a step of curing this seal on its supporting element. The invention also relates to a suspension bearing device and a strut of a motor vehicle.

### CROSS-REFERENCE TO RELATED APPLICATIONS

This application claims priority to French Patent Application 1254137, filed May 4, 2012, the specification of which is herein fully incorporated by reference.

### FIELD OF THE INVENTION

The present invention relates to a method for manufacturing a suspension bearing device, in particular of the MacPherson type (MacPherson Suspension Bearing or MSBU). The invention also relates to a suspension bearing device. The invention also relates to a motor-vehicle strut comprising a damper and one such suspension bearing device. The field of the invention is that of suspension systems particularly for motor vehicles.

### BACKGROUND OF THE INVENTION

In a known manner, a motor-vehicle suspension system comprises a strut supporting an axle and a wheel of a vehicle. A suspension bearing is placed in the top portion of the strut, opposite to the wheel and the ground, between a suspension spring and a top member secured to the body of the vehicle. The spring is placed around a damper piston rod of which the end may be secured to the body of the vehicle.

The suspension bearing comprises a rolling bearing, a bottom cup, a top cup and at least one seal placed between the cups. Except for the seal, the various elements forming the suspension bearing are usually made of metal in order to increase their mechanical strength. The top cup is interposed between a top race of the rolling bearing and the top member, while the bottom cup is interposed between a bottom race of the rolling bearing and the suspension spring. Therefore, the suspension bearing is suitable for transmitting axial forces between the suspension spring and the body of the vehicle, while allowing a relative angular movement between the races of the rolling bearing.

Such a suspension bearing, notably of the MSBU type, is required to be used in an aggressive environment. The vehicle is for example capable of running on a flooded, dusty or muddy road and then of being cleaned with a high-pressure water jet. In these conditions, ingress of water or of other polluting particles can occur in the bearing, notably in the rolling bearing, with consequences that are harmful to their service life and their respective performances. The seal or seals incorporated into the bearing are designed to prevent this ingress into the suspension bearing.

Documents U.S. Pat. No. 5,618,116, JP-A-1997 303 474 and JP-A-2009 002 425 describe various suspension bearings fitted with a seal. In each of these bearings, the rubber seals are overmolded onto a metal support, while their sealing lips rest on metal surfaces. Because of the sliding contact between the rubber seal and the metal surfaces, the seal and hence the reliability of such bearings are not entirely satisfactory.

FR-A-2 948 739 describes a suspension bearing device comprising a sealing member overmolded onto a bottom cup made of plastic. The sealing member covers the bottom cup on the bottom side and thus forms a bearing means for a suspension spring. The geometric configuration of the sealing member and of the cup makes these elements more complex to manufacture but, after overmolding, improves the relative mechanical adhesion between these elements.

### SUMMARY OF THE INVENTION

The object of the present invention is to propose an enhanced suspension bearing device.

Accordingly, the subject of the invention is a method for manufacturing a suspension bearing device, comprising at least one rolling bearing, a bottom cup and a top cup made of plastic, each in contact with the rolling bearing, and at least one seal suitable for protecting the rolling bearing from ingress of water or of polluting particles. The method is characterized in that it comprises at least one step of positioning a seal made of thermosetting elastomer on a supporting element made of plastic between the bottom cup and the top cup and, for the or each seal made of thermosetting elastomer, a step of curing this seal on its supporting element.

Thus, by virtue of the curing of the seal or of each seal made of elastomer directly onto its supporting element made of plastic, the mechanical adhesion between this supporting element and this seal is improved in comparison with the existing devices, comprising seals mounted on a metal support or overmolded onto a plastic support. Moreover, the use of seals made of elastomer, in particular of rubber, has several advantages in comparison with seals made of thermoplastic, for example of polyethylene TPE or of polyurethane TPU. The resistance torque is reduced at the end of the sealing lips in contact with the second cup opposite to the first cup of the support. The efficiency of the sealed contact of these lips on the second cup is also enhanced, which thus enhances the reliability and the performance in service of the suspension bearing device. Moreover, the properties of compression set and the resistance of the seals to abrasion are also enhanced, which increases their service life and hence the service life of the suspension bearing device.

The suspension bearing device obtained by the use of the method according to the invention may comprise several seals, of which at least one seal is made of thermosetting elastomer.

According to other advantageous features of the method according to the invention, taken in isolation or in combination:
For the or each seal made of thermosetting elastomer, the curing step is carried out at the same time as the step of positioning this seal on its supporting element.
For the or each seal made of thermosetting elastomer, the curing step is carried out after the step of positioning this seal on its supporting element.
For the or each seal made of thermosetting elastomer, the curing step is carried out before a step of assembling this seal and its supporting element with the rolling bearing and a second element, distinct from the supporting element between the bottom cup and the top cup, against which the seal is positioned in sealing contact.
For the or each seal made of thermosetting elastomer, the curing step is carried out before a step of assembling this seal and its supporting element with the rolling bearing and a second element, distinct from the supporting element between the bottom cup and the top cup, against which the seal is positioned in sealing contact.
For the or each seal, the positioning step is carried out at the same time as a step of molding this seal directly onto its supporting element, notably in a pressurized mold suitable for receiving this supporting element.
For the or each seal made of thermosetting elastomer, the step of positioning this seal directly on its supporting element is carried out after a preform step of the seal or seals in a pressurized mold.
For the or each seal made of thermosetting elastomer, the positioning step is carried out after a step of treating its supporting element, this treatment step including in particular the deposition of a fixing agent on at least one surface of the supporting element designed to receive this seal.
The method comprises a step of positioning at least two seals made of thermosetting elastomer on one and the same supporting element made of plastic and a step of simultaneous curing of these seals positioned on one and the same supporting element.

A further subject of the invention is a suspension bearing device which comprises at least one rolling bearing forming an axial stop along a main axis, and a bottom cup and a top cup made of plastic, each in contact with the rolling bearing. The bottom cup forms a bearing means for a suspension spring. The device also comprises at least one seal made of thermosetting elastomer cured onto a first element made of plastic between the bottom cup and the top cup and placed in sealing contact with the second element made of plastic between the bottom cup and the top cup.

Advantageously, the or each rolling bearing comprises a bottom race in contact with the bottom cup, a top race in contact with the top cup and at least one array of rolling elements placed between the races.

Also advantageously, the or each seal comprises a base of substantially annular shape from which extends at least one sealing lip placed in sealing contact with the second element made of plastic between the bottom cup and the top cup.

A further subject of the invention is a motor-vehicle strut, comprising a damper and a suspension bearing device as mentioned above.

### BRIEF DESCRIPTION OF THE DRAWINGS

The invention will be better understood on reading the following description given only as a non-limiting example and made with reference to the appended drawings in which:

FIG. 1 is a partial axial section of a strut according to the invention comprising a suspension bearing device also according to the invention and a damper rod and a suspension spring;

FIG. 2 is a section on a larger scale of the detail II in FIG. 1, showing the suspension bearing device comprising a rolling bearing, a bottom cup, a top cup and two seals overmolded onto the top cup;

FIG. 3 is a section similar to FIG. 1 showing a suspension bearing device according to a second embodiment of the invention, the damper rod and the suspension spring not being shown; and

FIG. 4 is a section similar to FIG. 2 showing the suspension bearing device of FIG. 3.

### DETAILED DESCRIPTION OF THE INVENTION

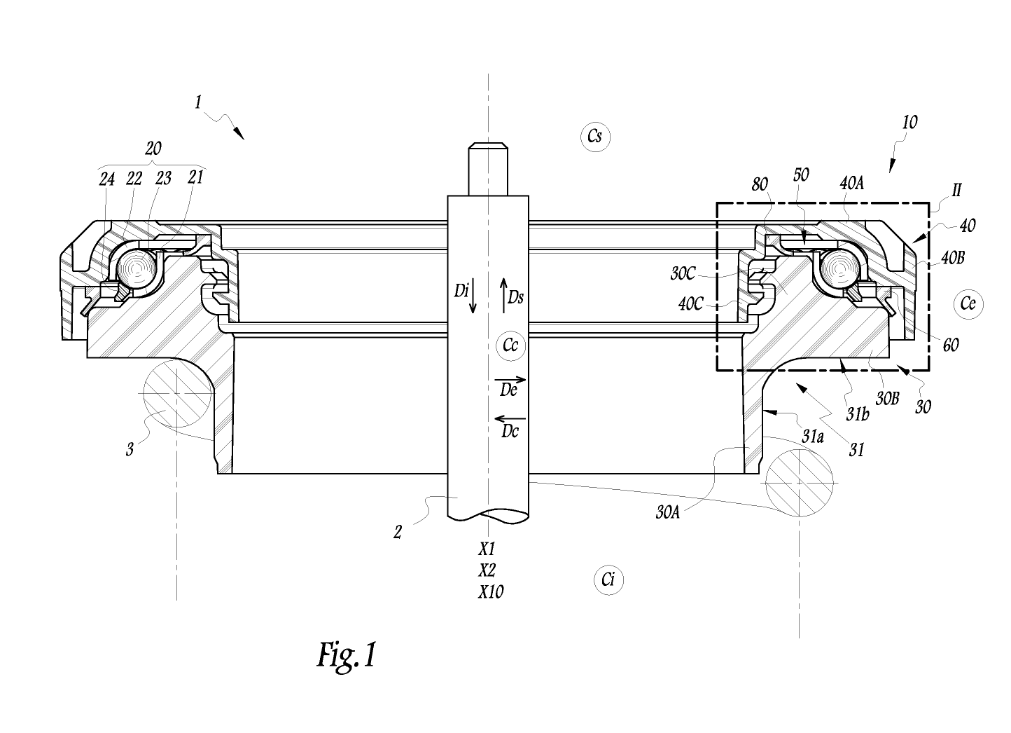

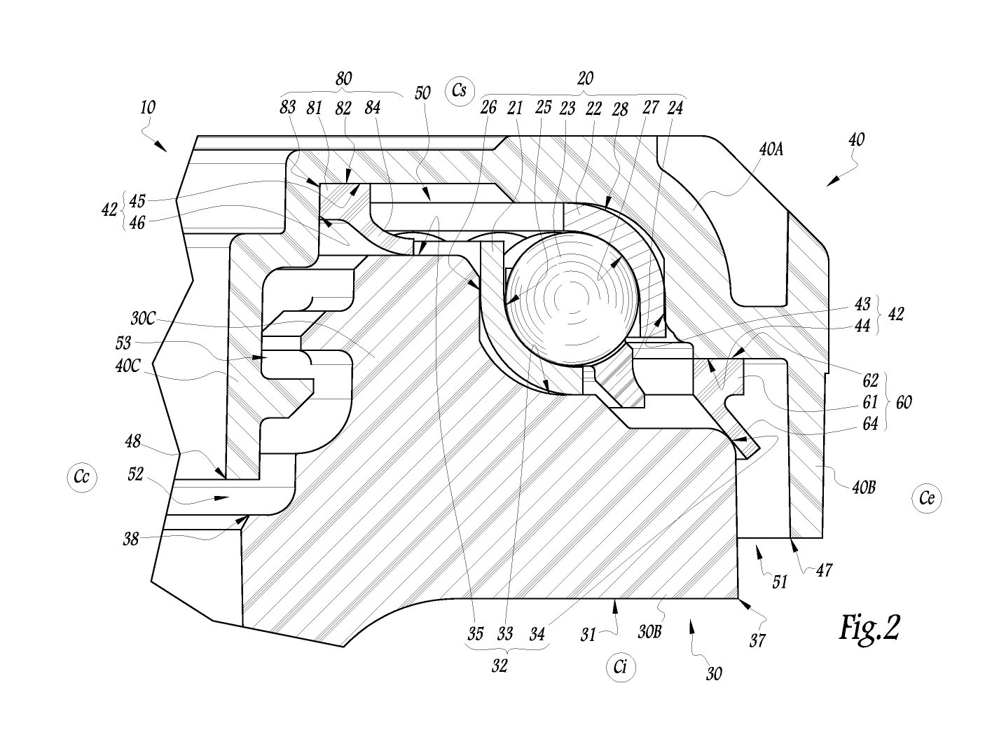

FIGS. 1 and 2 show a suspension bearing device 10 according to the invention, suitable for being fitted to a strut 1 also according to the invention.

The strut 1, partially shown in FIG. 1, is incorporated into a motor-vehicle suspension system. The strut 1 supports an axle and a wheel of a vehicle, not shown for the purposes of simplification. The strut 1 extends along a main axis X1 placed in a substantially vertical direction when the wheel of the vehicle rests on a flat ground. The strut 1 comprises a damper piston including a piston body and a damper rod 2, a suspension spring 3 and the suspension bearing device 10. The rod 2 and the spring 3 are partially shown in FIG. 1, while the piston body is not shown for the purposes of simplification.

Hereinafter, in order to make it easier to identify the device 10 in space, a bottom side Ci is defined on which are situated the ground and the wheel of the vehicle, and a top side Cs opposite to the bottom side Ci, to the ground and to the wheel. Also defined are an inner side Cc corresponding to the main axis X1, and an outer side Ce opposite to the axis X1 relative to the device 10. Also defined is a radial direction and an axial direction relative to the main axis X1. More precisely, a bottom axial direction Di directed towards the bottom side Ci parallel to the axis X1, a top axial direction Ds directed towards the top side Cs parallel to the axis X1, a central radial direction Dc directed towards the inner side Cc radially to the axis X1, and an outer radial direction De directed towards the outer side Ce radially to the axis X1 are defined.

The damper rod 2 extends along an axis X2 and slides in the body, not shown, of the damper piston. When the suspension system of the vehicle is at rest, the axis X2 of the rod 2 is indistinguishable from the main axis X1 of the strut 1, as in FIG. 1. The top portion of the strut 1, as well as the means for connecting the rod to this top portion, are not shown in the figures on the top side Cs for the purposes of simplification.

The suspension bearing device 10 comprises a single, angled-contact rolling bearing 20, a bottom cup 30, a top cup 40 and two seals 60 and 80. The device 10 and its constituent elements 20, 30, 40, 60 and 80 have overall a shape of revolution about a central axis X10. The cups 30 and 40 delimit between them a housing 50 inside the device 10, in which the rolling bearing 20 and the seals 60 and 80 are housed. Within the device 10, the cup 40 forms an element for supporting the seals 60 and 80 which come into sealed contact against the cup 30. In this example of FIG. 1, it is considered that the inner diameter of the device 10 about the axis X10 is of the order of 100 millimetres. When the suspension system of the vehicle is at rest, the axis X10 is indistinguishable from the axes X1 and X2, as in FIG. 1.

The suspension spring 3 is placed so as to rest between, on the one hand, on the bottom side Ci, the body of the damper piston and, on the other hand, on the top side Cs, the bottom cup 30 fitted to the suspension bearing device 10. The spring 3 is wound around the rod 2 and the axis X1. The spring 3 is elastically deformable according to the stresses exerted on the suspension system of the vehicle. The spring 3 exerts axial forces, in the top direction Ds, against the cup 30, which transmits these forces to the device 10. In this case, an axial movement of the bottom cup 30 relative to the top cup 40 may occur in the direction Ds, because of the inner clearances of the device 10.

The rolling bearing 20 includes a bottom and inner race 21, a top and outer race 22, and rolling elements 23 in angled contact placed between the inner race 21 and the outer race 22, in a cage 24. The inner race 21 is radially closer to the axis X10 than the outer race 22. The inner race 21 is situated on the inner-bottom side Cc+Ci, while the outer race 22 is situated on the outer-top side Ce+Cs. The races 21 and 22 are preferably metal and formed by stamping. In this case, each of the races 21 and 22 forms a stamped raceway for the rolling elements 23 within the rolling bearing 20. More precisely, the inner race 21 comprises an outer surface 24 forming a raceway for the elements 23 and an inner surface 26 bearing against the bottom cup 30, while the outer race 22 comprises an inner surface 27 forming a raceway for the elements 23 and an outer surface 26 bearing against the top cup 40.

In practice, the rolling bearing 20 forms an axial stop within the device 10, between the cups 30 and 40, in the directions Ds and Di. Thus, the rolling bearing 20 and the device 10 form an axial stop within the strut 1. The rolling bearing 20 allows, on the one hand, a relative pivoting between the races 21 and 22 about the axis X10 and, on the other hand, an inclination of the axis X2 of the rod 2 relative to the body of the vehicle. The rolling bearing 20 is preferably in angled contact in order to limit the forces and frictions inside the device 10 in service. In the example of FIGS. 1 and 2, the rolling elements 23 are balls, of which the angled contact with the races 21 and 22 is directed along an axis inclined substantially at 45° relative to the axis X10. As an alternative example, the rolling elements 23 may be rollers.

The bottom cup 30 comprises an axial portion 30A, a radial portion 30B, and a portion 30C inside the device 10, bordering the housing 50 on the bottom side Ci. The portions 30A and 30B form overall an L in the hollow of which a concave surface 31 bearing on the spring 3 is formed. The concavity of the surface 31 is oriented in the outer-bottom direction De+Di. On either side of the concavity, the surface 31 is extended by a flat portion 31a on the outer side Ce of the axial portion 30A and by a flat portion 31b on the bottom side Ci of the radial portion 30B. The portion 30C extends in the top direction Ds from the top side Cs of the radial portion 30B and comprises a face 32 inside the housing 50. The inner face 32 comprises a concave surface 33 receiving the surface 26 of the bottom race 21 of the angled rolling bearing 20 in an inner-bottom direction Dc+Di. The inner face 32 also comprises a rounded convex surface 34 against which the seal 60 comes into sealing contact, and a radial annular surface 35 against which the seal 80 comes into sealing contact.

The top cup 40 comprises a median portion 40A, an outer portion 40B and an inner portion 40C. The median portion 40A, thicker and therefore stronger than the portions 40B and 40C, receives the outer race 22 of the angled rolling bearing 20 in an outer-top direction De+Ds. The outer portion 40B extends in the bottom direction Di, from the outer side Ce of the median portion 40A. The inner portion 40C extends from the median portion 40A forming an L, first in the central radial direction Dc and then overall in the bottom axial direction Di. The cup 40 comprises a face 42 inside the housing 50, which extends on the portions 40A, 40B and 40C, as explained in detail below. The inner face 42 borders the housing 50 simultaneously on the inner side Cc, top side Cs and outer side Ce.

In practice, the bottom cup 30 transmits to the rolling bearing 20 forces that are essentially axial, exerted on the device 10 by the suspension spring 3. More precisely, these forces are directed essentially in the top direction Ds and are transmitted by the spring 3 to the cup 30, then to the rolling bearing 20, then to the cup 40. In the context of the invention, the cups 30 and 40 are made of plastic, for example of polyamide PA66 or PA6. This plastic is sufficiently strong in service in the conditions of operation of the device 10. This plastic enhances the adhesion between the seals 60 and 80 and the cups 30 and 40, in comparison with metal cups.

The sealing of the housing 50, delimited between the cups 30 and 40, is considerable so as not to disrupt the operation of the rolling bearing 20 and of the bearing 10. The housing 50 comprises an outer opening 51 delimited between an edge 37 belonging to the radial portion 30B of the bottom cup 30 and an edge 47 belonging to the outer portion 40B of the top cup 40. Similarly, the housing 50 comprises an inner opening 52 delimited between an edge 38 belonging to the bottom cup 30, situated in the corner of the L formed by the portions 30A and 30B, and an edge 48 belonging to the inner portion 40C of the top cup 40. From the opening 52, the portions 30B and 30C of the bottom cup 30 and the portion 40C of the top cup 40 form a labyrinth 53 inside the housing 50.

The seals 60 and 80 are positioned on the top cup 40, respectively at the opening 51 and the opening 52. The seals 60 and 80 each comprise a sealing lip, respectively 64 and 84, received in sealed contact against the bottom cup 30, respectively against the surface 34 and against the surface 35 of the inner face 32. In practice, the lips 64 and 84 are deformable against the cup 40 when the device 10 is in service, while maintaining the sealed contact. In particular, the lip 84 is shown deformed in contact with the cup 30 in FIGS. 1 and 2.

In practice, the labyrinth 53 and the seals 60 and 80 make it possible to prevent ingress of water or of other polluting particles into the housing 50, simultaneously from the inner side Cc and from the outer side Ce of the device 10.

As shown in FIG. 2, the inner face 42 of the top cup 40 comprises a concave surface 43 receiving the surface 28 of the outer race 22 of the rolling bearing 20. The face 42 also comprises a radial annular surface 44 arranged on the portion 40A, between the rolling bearing 20 and the opening 51, designed to receive the seal 60. The face 42 also comprises a radial annular surface 45 and an axial cylindrical surface 46, arranged on the portion 40C between the rolling bearing 20 and the labyrinth 53, designed to receive the seal 80. The face 42 is situated opposite the face 32, the said faces being sufficiently close together for the lips 64 and 84 of the seals 60 and 80 to extend across the housing 50.

The outer seal 60 is placed on the outer side Ce of the device 10 and is designed to provide the seal at the outer opening 51 of the device 10, while the inner seal 80 is placed on the inner side Cc of the device 10 and is designed to provide the seal at the inner opening 52 of the device 10, as a complement of the labyrinth 53. The seal 60 comprises a base 61 of substantially annular shape surrounding the axis X10, from which the sealing lip 64 extends. The seal 80 comprises a base 81 of substantially annular shape surrounding the axis X10, from which the sealing lip 84 extends. The base 61 comprises a radial annular surface 62 suitable for being positioned against the surface 44 of the cup 60 on the top side Cs. The base 81 comprises a radial annular surface 82 and an axial cylindrical surface 83, the said surfaces being suitable to be positioned respectively against the surfaces 45 and 46 of the cup 40, in a corner of the portion 40C. The annular shape of the bases 61 and 81 is simple in comparison with certain existing devices, comprising L-shaped or U-shaped bases, which simplifies the manufacture of the seals 60 and 80 and their incorporation into the device 10.

The seals 60 and 80 are made of thermosetting elastomer, preferably of rubber, cured directly on the cup 40, as explained in detail below. Using seals 60 and 80 made of elastomer, in particular of rubber, has several advantages in comparison with seals made of thermoplastic, for example of polyethylene TPE or of polyurethane TPU. The resistant torque is reduced at the end of the lips 64 and 84 in contact with the cup 40. The efficiency of the sealed contact of these lips 64 and 84 on the cup 40 is also enhanced. The compression set of the seals 60 and 80 is also enhanced. The resistance of the seals 60 and 80 to abrasion is also enhanced, which increases their service life. By virtue of the curing of the seals 60 and 80 directly onto the cup 40, the mechanical adhesion between the plastic of the cup 30 and the elastomer of the seals 60 and 80 is enhanced, in comparison with the devices in which the seals are mounted on a metal support.

The various steps of the method for manufacturing the suspension bearing device 10 are explained in detail below.

The method comprises steps for manufacturing the rolling bearing 20, the cup 30, the cup 40 and the seals 60 and 80, which are usually distinct and can be accomplished simultaneously or in any order.

Preferably, the method comprises a step of treating the cup 40, the said step being designed to enhance the final adhesion between this cup 40 and the seals 60 and 80. In particular, this treatment step may include the deposition of a fixing agent on the surfaces 44, 45 and 46 of the cup 40 which are designed to receive the seals 60 and 80. As an alternative or in addition, this step may include any treatment suitable for the present application.

The method comprises, for each of the seals 60 and 80, a molding step consisting in giving it its overall shape. This molding step is usually carried out in a pressurized mold. As a non-limiting example, the seal 60 or 80 made of rubber may be molded at a pressure higher than or equal to 50 bar and at a temperature of between 60 and 150° C. According to a first method of molding, each seal 60 or 80 may be molded alone, without the cup 40 being placed in the mold. In this case, the molding step makes it possible to obtain a preform of the seal 60 or 80, which is subsequently positioned on the cup 40. According to a second molding method, each seal 60 or 80 may be molded directly onto the cup 40. In this case, the mold is suitable for receiving this cup 40.

The method also comprises, for each of the seals 60 and 80, a step of positioning this seal on the cup 40. According to a first positioning method, each seal 60 or 80 may be positioned on the cup 40 after the preform step by molding. According to a second positioning method, each seal 60 or 80 may be positioned directly onto the cup 40 in the pressurized mold, at the same time as the molding step. In this case, the two seals 60 and 80 may be molded and positioned simultaneously in one and the same mold, or successively in two different molds, onto the cup 40.

The method also comprises, for each of the seals 60 and 80, a step of curing on the cup 40. According to a first curing method, each seal 60 or 80 may be cured on the cup 40 after the positioning step, notably in a specific curing mold. According to a second curing method, each seal 60 or 80 may be cured directly on the cup 40, at the same time as the positioning step. In this case, preferably, the molding, positioning and curing steps of one and the same seal 60 and 80 are carried out simultaneously, that is to say without interruption, without removing the cup 40 from the mold. Also preferably, the toolage is then suitable for forming, positioning and curing the two seals 60 and 80 simultaneously on the cup 40.

The method also comprises a step of assembling the cup 40 furnished with the seals 60 and 80 with the rolling bearing 20 and the cup 30, thus forming the complete device 10. According to a first assembly method, this step is carried out after the curing step or steps. According to a second assembly method, this step is carried out after the positioning step or steps and before the step or steps for curing the seals 60 and 80 on the cup 40. During this assembly step, each of the seals 60 and 80 comes into sealing contact with the cup 30.

As an alternative, the method for manufacturing the device 10 may be carried out differently without departing from the context of the invention.

For example, the device 10 may comprise a single seal 60 or 80. According to another example, the seals may be cured on the cup 30 as a supporting element, while their lips come into contact with the cup 40. According to another example, the cup 30 may receive a first seal, while the cup 40 receives a second seal, which seals protect the rolling bearing 20 on each of its sides, the inner side Cc and outer side Ce.

Irrespective of the production method, the method comprises, for the or each seal 60 and/or 80 made of thermosetting elastomer, a step of curing this seal on its supporting element 30 or 40. A molding step, a positioning step and a curing step, which may be in succession or virtually simultaneous, are associated with each seal 60 or 80.

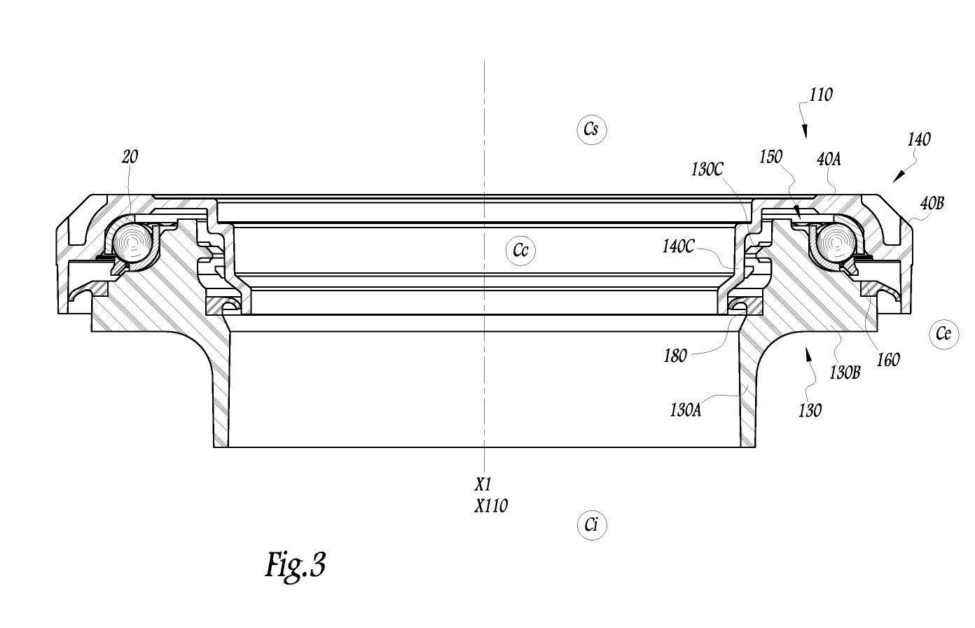

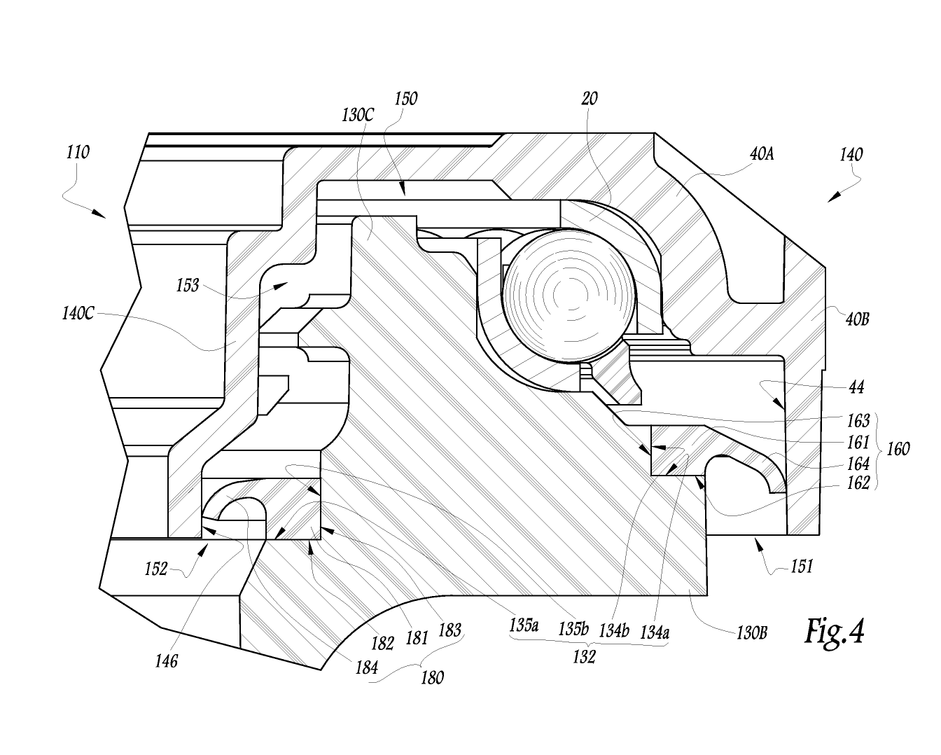

FIGS. 3 and 4 show a second embodiment of a suspension bearing device 110 according to the invention.

The device is suitable for being fitted to the strut 1 of FIG. 1. The rod 2 and the spring 3 are not shown in FIG. 3 for the purposes of simplification.

Certain elements forming the device 110 have a similar operation but a different structure, in comparison with the elements forming the device 10 described above, and bear the same reference numbers increased by 100. These are the seal 160 comprising a base 161, positioning surfaces 162 and 163 and a lip 164, the seal 180 comprising a base 181, positioning surfaces 182 and 183 and a lip 184, the cup 130, its portions 130A, 130B and 130C, the face 132 comprising surfaces 134a and 134b for positioning the surfaces 162 and 163 of the seal 160 and surfaces 135a and 135b for positioning the surfaces 182 and 183 of the seal 180, the cup 140, its portion 140C, the surface 146 receiving the lip 184 of the seal 180 in sealed contact, the housing 150, openings 151 and 152, the labyrinth 153 and the axis X110.

Other elements forming the device 110 are identical to those of the device 10 described above and bear the same reference numbers. These are the rolling bearing 20, the portions 40A and 40B and the surface 44 of the cup 140.

The main difference with the first embodiment relates to the positioning of the seals 160 and 180 on the bottom cup 130. More precisely, the seal 160 is positioned at the opening 151 in a housing formed by the surfaces 134a and 134b of the cup 130, while the seal 180 is positioned at the opening 152 in a housing formed by the surfaces 135a and 135b of the cup 130. The lips 164 and 184 of the seals 160 and 180 are received in sealing contact on the cup 140, respectively against the surface 44 and against the surface 146.

Apart from this difference, the device 110 may be manufactured according to a method similar to that of the device 10 described above. Preferably, the surfaces 134a, 134b, 135a and 135b receive a treatment prior to the positioning of the seals 160 and 180, such as the deposition of a fixing agent. The seals 160 and 180 are made of thermosetting elastomer and are cured on their supporting element, namely the cup 140.

Furthermore, the strut 1 may be formed in a manner that differs from the figures without departing from the context of the invention. In particular, at least certain elements forming the device 10 or 110 may be formed differently from FIGS. 1 to 4 without departing from the context of the invention.

As a variant not shown, the suspension bearing device 10 or 110 may be fitted to a suspension system other than that of a motor vehicle.

According to another variant not shown, the rolling bearing 20 does not have to be an angled bearing, but a straight bearing.

According to another variant not shown, at least one raceway 20 may be formed directly on the cup 30 and/or on the cup 40.

According to another variant not shown, the device 10 or 110 may comprise seals made of elastomer, which are cured on their supporting element, and other seals made of thermoplastic which are preferably overmolded onto their supporting element.

According to another variant not shown, the cups 30 and 40 may be formed with the corner 37 which is further from the axis X1 on the outer side Ce than the corner 47, while the corner 38 is closer to the axis X1 on the inner side Cc than the corner 48. Therefore, the openings 51 and 52 are yet better protected from ingress which may originate from the inner side Ci and the wheel, as is often the case.

According to another variant not shown, the seal 60, 80, 160 and/or 180 may comprise two sealing lips in contact with the second element distinct from the first supporting element between the two cups. Therefore, the risks of ingress of water or of polluting particles in the inner housing 50 of the device 10 are further reduced.

Irrespective of the embodiment, the device 10 or 110 comprises a bottom cup 30 or 130 and a top cup 40 or 140 made of plastic, each in contact with the rolling bearing 20, and at least one seal 60, 80, 160 and/or 180 made of thermosetting elastomer cured on a first element made of plastic between the bottom cup and the top cup and placed in sealing contact with the second element made of plastic between the bottom cup and the top cup. By using a maximum of elements made of plastic or elastomer, the cost of the device is reduced in comparison with the devices using metal elements.

Moreover, the technical features of the various embodiments may be, in totality or for certain of them, combined together. Therefore, the suspension bearing device and the strut may be adapted in terms of cost, performance and simplicity of implementation.

1. A method for manufacturing a suspension bearing device, the method comprising the steps of:
providing at least one rolling bearing, a bottom cup and a top cup made of plastic, each in contact with the rolling bearing, and at least one seal suitable for protecting the rolling bearing from ingress of water or of polluting particles,
positioning a seal made of thermosetting elastomer on a supporting element made of plastic between the bottom cup and the top cup and,
curing the seal made of thermosetting elastomer, on its supporting element.

2. The method according to claim 1, wherein the curing step is carried out at the same time as the step of positioning this seal on its supporting element.

3. The method according to claim 1, wherein the curing step is carried out after the step of positioning this seal on its supporting element.

4. The method according to claim 1, wherein the curing step is carried out before a step of assembling the seal and its supporting element with the rolling bearing and a second element, distinct from the supporting element disposed between the bottom cup and the top cup, against which the seal is positioned in sealing contact.

5. The method according to claim 3, wherein the curing step is carried out before a step of assembling the seal and its supporting element with the rolling bearing and a second element, distinct from the supporting element between the bottom cup and the top cup, against which the seal is positioned in sealing contact.

6. The method according to claim 1, wherein the step of positioning is carried out at the same time as a step of molding this seal directly onto its supporting element, notably in a pressurized mold suitable for receiving this supporting element.

7. The method according to claim 1, wherein the step of positioning the seal directly on its supporting element is carried out after a preform step of the seal or seals in a pressurized mold.

8. The method according to claim 1, wherein the step of positioning is carried out after a step of treating its supporting element, this treatment step including the deposition of a fixing agent on at least one surface of the supporting element designed to receive the seal.

9. The method according to claim 1, further comprising:
positioning at least two seals made of thermosetting elastomer on the supporting element made of plastic, and
simultaneously curing the seals positioned on the supporting element.

10. A suspension bearing device comprising:
at least one rolling bearing forming an axial stop along a main axis,
a bottom cup and a top cup made of plastic, each in contact with the rolling bearing, wherein
the bottom cup forms a bearing means for a suspension spring, and
at least one seal made of thermosetting elastomer cured onto a first element made of plastic disposed between the bottom cup and the top cup and placed in sealing contact with the second element made of plastic between the bottom cup and the top cup.

11. The suspension bearing device according to claim 10, wherein each rolling bearing comprises a bottom race in contact with the bottom cup, a top race in contact with the top cup and at least one array of rolling elements placed between the races.

12. The suspension bearing device according to claim 10, wherein each seal includes a base of substantially annular shape from which extends at least one sealing lip placed in sealing contact with the second element which is made of plastic and is disposed between the bottom cup and the top cup.

13. A motor-vehicle strut comprising:
a damper, and
a suspension bearing device having;
at least one rolling bearing forming an axial stop along a main axis,
a bottom cup and a top cup made of plastic, each in contact with the rolling bearing, wherein
the bottom cup forms a bearing means for a suspension spring, and
at least one seal made of thermosetting elastomer cured onto a first element made of plastic disposed between the bottom cup and the top cup and placed in sealing contact with the second element made of plastic between the bottom cup and the top cup.
